(19) United States
(12) Patent Application Publication
(10) Pub. No.: US 2006/0181834 A1
(43) Pub. Date: Aug. 17, 2006

(54) Knob for trimmer capacitors

(76) Inventor: Gerardo Becerra, Palmdale, CA (US)

Correspondence Address: Gerardo Becerra, 6358 Vittoria Avenue, Palmdale, CA, 93552, US

(21) Appl. No.: 11/060,334

(22) Filed: Feb. 17, 2005

(51) Int. Cl. H01G 9/00; H01G 5/06

(52) U.S. Cl. 361/293; 29/25.03; 361/321.2; 29/593

(57) ABSTRACT

A Knob (1) design for providing easy adjustability of a trimmer capacitor (2). Both pieces attached with a strong adhesive/epoxy. A user of the knob for trimmer capacitors now has the ability to turn/adjust the trimmer capacitor by using one fingertips or standard screwdriver. Thus a considerably more versatile trimmer capacitor.

### BACKGROUND

This invention relates to trimmer capacitors, specifically in the area of adjustment. Trimmer capacitors are cumbersome to adjust. A specialized or very fine screwdriver is needed to properly fit the standard adjustment screw-head on trimmer capacitors. When installed in a circuit, access and adjustment become very difficult. If any adjustments are needed, one must insert a special screwdriver thru a small opening on the chassis and blindly rely on feel to position the screwdriver on the trimmer capacitor. Many times a trimmer capacitor will break due to the amount of pressure that's needed when trying to make adjustments by feel.

In conclusion, insofar as I am aware, no trimmer capacitor formerly developed provides easy adjustments and accessibility without the use of a specialized tool/screwdriver.

### SUMMARY

The invention, a knob for trimmer capacitors, is designed to fit the screw-head for easy adjustment and access by using ones fingertips or a screwdriver (if desired). The knob is designed to fit over the trimmer capacitors adjustment head. This ensures that the knob is centered when attached to the trimmer capacitor using a strong adhesive/epoxy. Now, with a knob attached, the user can easily make adjustments via ones fingertips. Various knob lengths allow for specific user applications. Lengths may vary depending on the placement of the trimmer capacitor and the need for access.

Accordingly several advantages of the invention are to provide an improved trimmer capacitor, to provide easy user friendly fingertip adjustments, to provide a trimmer capacitor that's easily accessible, and to provide faster calibration/testing time. Further advantages will become apparent from a study of the following description and the accompanying drawings.

### DRAWINGS

FIG. 1 is a front view of the knob for Trimmer Capacitors, showing a phillip-screwdriver or flat screwdriver slot.

FIG. 2 is a side view of the Knob for Trimmer Capacitors of FIG. 1.

FIG. 3 is a side view of the Knob for Trimmer Capacitors of FIG. 2, showing the ability for various Knob lengths.

FIG. 4 is a rear view of FIG. 2 & FIG. 3, showing the circular fitting that mounts on the screw-head of a Trimmer Capacitor.

FIG. 5 is a side view of the Knob for Trimmer Capacitors of FIG. 2 attached to the screw-head of a Trimmer Capacitor.

FIG. 6 is a side view showing the ability to attach different Knob lengths as in FIG. 5.

FIG. 7 is a front view of a Trimmer Capacitor with the Knob attached.

### DESCRIPTION

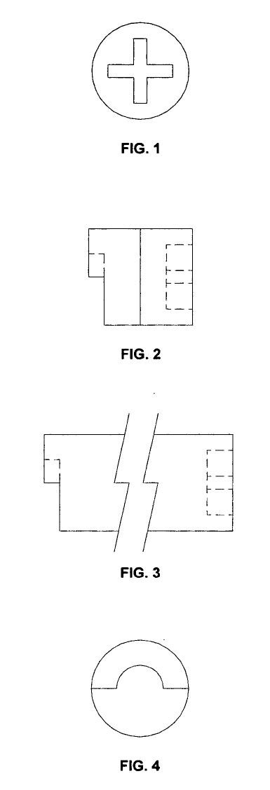

FIG. 1 is a front perspective of the Knob 1 showing the ability to insert a regular flathead or philips screwdriver.

FIG. 2 is a lateral perspective of the Knob 1 showing the ability to fit on a Trimmer Capacitors 2 adjustment screwhead.

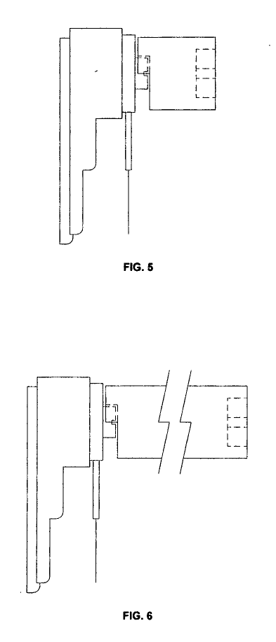

FIG. 3 is a lateral perspective showing the Knob's 1 ability to be made at various lengths if needed.

FIG. 4 is a rear view showing the Knob 1 which fits/sits on a Trimmer Capacitors 2 adjustment screwhead.

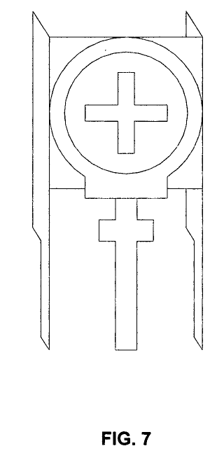

FIG. 5 is a lateral perspective of a Trimmer Capacitor 2 with a Knob 1 fastened onto it.

FIG. 6 is a lateral perspective of a Trimmer Capacitor 2 & Knob fastened onto it. The Knob 1 can be made to accommodate various lengths.

FIG. 7 is a front view of a fastened Knob 1 for Trimmer Capacitors 2.

### REFERENCE NUMERALS

1 Knob
2 Trimmer Capacitor

### OPERATION

In operation a person uses a Trimmer Capacitor in a normal manner. The user can, when equipped with the Knob for Trimmer Capacitors, adjust the trimmer by using ones fingertips (as turning a small knob on a radio)(FIG. 5 or 6). When the Knob is attached to a Trimmer Capacitor, 3 effects increase a trimmer capacitors versatility:
(1) The Knob allows the user adjust a trimmer capacitor without a specialized tool.
(2) A trimmer capacitor equipped the a knob can easily be turned/adjusted using ones fingers or by using a standard flathead/phillips screwdriver.
(3) The Knob can be made at various lengths (FIG. 3 & FIG. 6) to accommodate different applications.

1. A method of joining a Knob to a standard Trimmer Capacitor, comprising:
a. providing said Knob and positioning it on the trimmer capacitor's screw-head, and
b. applying an adhesive/epoxy to adhere both knob and trimmer capacitor, whereby said two pieces will be attached for ease of use.
